(19) United States
(12) Patent Application Publication
(10) Pub. No.: US 2020/0248615 A1
(43) Pub. Date: Aug. 6, 2020

(54) Turbocharger with a Casing and Internal Combustion Engine

(71) Applicant: Man Energy Solutions SE, Augsburg (DE)

(72) Inventors: Steffen BRAUN, Augsburg (DE); Urban SPATZ, Neusäße (DE); Daniel ALBRECHT, Augsburg (DE); Harald DENKEL, Baar (DE); Stefan WEIHARD, Augsburg (DE); Bernd HAAS, Neusäß (DE); Johannes NIEBUHR, Augsburg (DE)

(21) Appl. No.: 16/782,742

(22) Filed: Feb. 5, 2020

(30) Foreign Application Priority Data
Feb. 6, 2019 (DE) 10 2019 102 874.4

(51) Int. Cl. F02B 37/00; F02C 6/06; F02B 75/18; F02C 7/06; F02C 7/20

(52) U.S. Cl. CPC F02B 37/00; F02C 6/06; F02B 75/18; F05D 2240/90; F02C 7/20; F05D 2220/40; F02C 7/06

(57) ABSTRACT

A turbocharger includes a turbine for expanding a first medium and a compressor for compressing a second medium utilizing energy extracted in the turbine during the expansion of the first medium. A turbine housing of the turbine and a compressor housing of the compressor each are connected to a bearing housing arranged therebetween. A casing: surrounds the turbine housing radially outside and axially outside at least in certain sections, and/or surrounds the compressor housing radially outside and axially outside at least in certain sections. The respective casing is positioned loosely around the turbine housing without direct connection to the turbine housing or loosely around the compressor housing without direct connection to the compressor housing. The respective casing is connected to an assembly which, during the operation of the turbocharger, has a temperature level corresponding to the respective casing.

### BACKGROUND OF THE INVENTION

### 1. Field of the Invention

The invention relates to a turbocharger with a casing and to an internal combustion engine.

### 2. Description of the Related Art

The fundamental construction of a turbocharger is known to the person skilled in the art. A turbocharger comprises a turbine, in which a first medium is expanded. Furthermore, a turbocharger comprises a compressor, in which a second medium is compressed, namely utilizing energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing is connected on the one hand to the turbine housing and on the other hand to the compressor housing. In the bearing housing, a shaft is mounted via which the turbine rotor is coupled to the compressor rotor.

During the operation of a turbocharger there is the danger that a rotor, for example the turbine rotor of the turbocharger, breaks and fragments of the rotor strike through the relevant housing, i.e., the turbine housing. There is then the danger that the fragments of the turbocharger enter the surroundings. In order to take into account this problem of the bursting of a rotor of the turbocharger the respective housing in turbocharger known from practice is designed in such a manner that a case of damage of the respective housing need not be expected and even when the respective rotor should break, fragments of the same cannot strike through the respective housing. However, the weight of the turbocharger is increased because of this.

In order to not unnecessarily increase the weight of the turbocharger and additionally protect turbochargers already employed in the field against fragments of a rotor striking through into the surroundings, it is already known from practice to equip a turbocharger with a casing, which at least in certain sections surrounds the respective housing to be encased, i.e., the turbine housing or compressor housing, radially outside and axially outside.

In turbochargers known from practice, the casing for the turbine is directly connected to the turbine housing and the casing for the compressor directly to the compressor housing. Because of a temperature difference between the casing and the turbine housing or between the casing and the compressor housing forming during the operation, the relevant connecting elements have to satisfy multiple requirements. Accordingly, an adequate resilience of the connecting elements is required in order to compensate for thermally-induced relative movements between the casing and the housing that is at least in certain sections surrounded by the casing, namely without impermissibly high constraint forces developing by way of elongation conditions. However, an adequately stiff connection is required at the same time in order to provide high natural frequencies and avoid a vibration excitation of the casing. For this reason, complex and expensive connecting elements are employed in turbochargers known from practice. This is disadvantageous. There is a need for a turbocharger in which a casing for the turbine housing and/or a casing for the compressor housing can be assembled using simple and cost-effective connecting elements.

### SUMMARY OF THE INVENTION

Starting out from this, it is an object of the invention to provide a new type of turbocharger and an internal combustion engine having such a turbocharger.

This object may be attained through a turbocharger in which, the respective casing is loosely positioned around the turbine housing without direct connection to the turbine housing or loosely around the compressor housing without direct connection to the compressor housing. The respective casing is connected to an assembly which during the operation of the turbocharger has a temperature level corresponding to the respective casing. In one aspect of the invention, the respective casing around the respective casing, i.e., around the turbine housing or the compressor housing, is positioned loosely without direct connection to the respective housing. The respective casing is rather connected to an assembly which during the operation of the turbocharger has a temperature level corresponding to the respective casing. By way of this it is not necessary that the connecting elements, which serve for mounting the respective casing, have to compensate for temperature-induced relative movements. The same can be embodied rigidly in order to provide an adequately high natural frequency. The connecting elements can be embodied simpler and more cost-effectively.

According to an advantageous further development, the respective casing is connected to the bearing housing. The connection of the respective casing to the bearing housing is preferred. This allows a simple connection of the respective casing to the turbocharger.

Preferentially, the respective casing is connected to the bearing housing via brackets preferentially such that the brackets at an end are connected to the bearing housing and at a second end are connected to the respective casing, wherein at the second ends of the brackets elongated holes are formed, which permit connecting the respective casing in different angular positions. In this manner, it is ensured that the respective casing, if required together with the housing to be encased, can be mounted in different relative positions relative to the bearing housing to the same.

Additionally or alternatively, to the connection to the bearing housing, the respective casing can be connected to the engine and/or a support structure or console for assemblies of the internal combustion engine. Thus, the respective casing can also be connected to the engine or to the support structure or console. There is then no direct connection of the respective casing to the housing to be encased, i.e., to the turbine housing or to the compressor housing in this case either.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the the following. Exemplary embodiments of the invention are explained in more detail by way of the drawings without being restricted to this. In the drawings:

FIG. 1 is a lateral view of an internal combustion engine together with a generator;

FIG. 2 shows a casing for a turbocharger of the internal combustion engine without the housing of the turbocharger to be encased; and

FIG. 3 shows an extract from a turbocharger in the region of a bearing housing, of a turbine housing and of a casing of the turbine housing.

### DETAILED DESCRIPTION OF THE PRESENTLY PREFERRED EMBODIMENTS

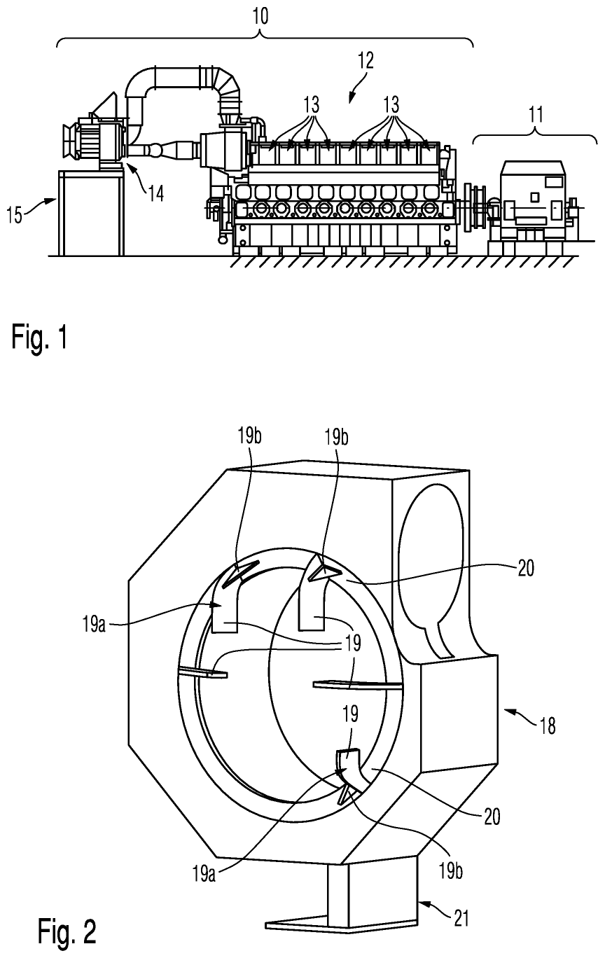

FIG. 1 shows a lateral view of an internal combustion engine 10 together with a generator 11 driven by the internal combustion engine 10. The internal combustion engine 10 of FIG. 1 is purely exemplary in nature. The invention is not restricted to internal combustion engines 10 that drive a generator 11.

The internal combustion engine 10 comprises an actual engine 12 having multiple cylinders 13. In the cylinders 13 of the engine 10 a fuel is combusted. This fuel can be a liquid fuel or a gaseous fuel. The engine 12 can be, for example, a gas engine, a diesel engine or a dual fuel engine.

The internal combustion engine 10 comprises a turbocharger 14. The turbocharger 14 is mounted on a support structure 15 in FIG. 1, which can also be referred to as console.

The person skilled in the art is familiar with the fundamental construction of a turbocharger 14. Accordingly, a turbocharger 14 comprises a turbine for expanding a first medium, in particular for expanding the exhaust gas, which is incurred during the combustion of the fuel in the cylinders 13 of the engine 12. Furthermore, the turbocharger 14 comprises a compressor for compressing a second medium, in particular for compressing charge air, which is provided to the cylinders 13 of the engine 12 for combusting the fuel.

The turbine of the turbocharger 14 comprises a turbine rotor and a turbine housing. The compressor of the turbocharger 14 comprises a compressor rotor and a compressor housing. Turbine rotor and compressor rotor are coupled via a shaft. The shaft is mounted on a bearing housing of the turbocharger, wherein the bearing housing is positioned between the turbine housing and the compressor housing and connected both to the turbine housing and also to the compressor housing.

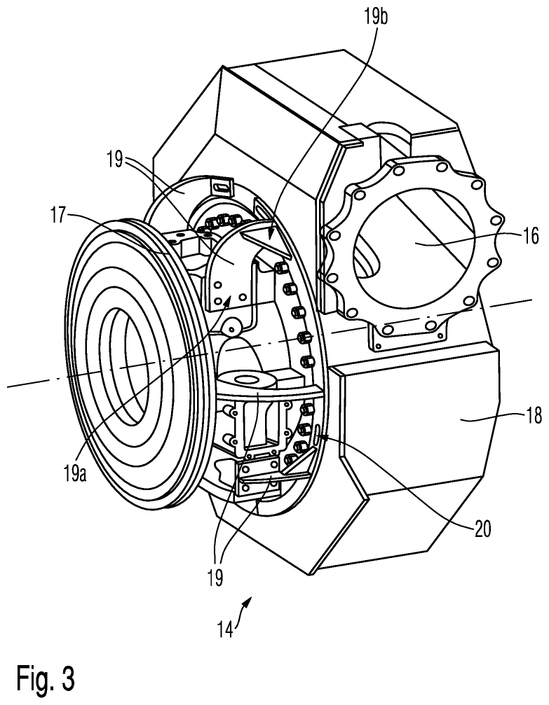

FIG. 3 shows an extract from a turbocharger 14 in the region of a turbine housing 16 and of a bearing housing 17.

During the operation there is a danger that the turbine rotor of the turbine of the turbocharger 14 or the compressor rotor of the compressor of the turbocharger 14 may break. In such an occurrence, fragments of the respective rotor can then strike through the respective housing, i.e., the turbine housing or the compressor housing and enter the surroundings. This has to be avoided and for this purpose it is known to equip a turbocharger with at least one casing. Accordingly, FIG. 3 shows a casing 18 for the turbine of the turbocharger, the casing 18 surrounding the turbine housing 16 in certain sections axially and radially outside.

Preferentially, such casings are employed both in the region of the turbine and also in the region of the compressor that surrounds the respective housing, i.e., the turbine housing 16 or the compressor housing radially outside and axially outside at least in certain sections.

In terms of the invention the respective casing is positioned loosely around the respective housing to be encased without direct connection to the respective housing to be encased. In FIG. 3, the casing 18 is positioned around the turbine housing 16 without direct connection to the turbine housing 16. In the region of the compressor, such a casing is positioned around the compressor housing without direct connection to the compressor housing.

According to the invention, the respective casing 18 is connected to an assembly which, during the operation of the turbocharger 14, has a temperature level corresponding to the casing 18. Accordingly, the casing 18, in FIG. 3, which is arranged around the turbine housing 16 without direct connection to the turbine housing 16, is connected to the bearing housing 17. In FIG. 3, this purpose is served by multiple brackets 19, which at a first end 19a are connected to the bearing housing 17 and with a second end 19b located opposite are connected to the casing 18 for the turbine housing 16.

Accordingly one purpose of the present invention is to connect a casing 18 of a turbocharger 14 not to the housing to be encased, but rather to an assembly which during the operation of the turbocharger 14 has a temperature level corresponding to the casing 18.

In the exemplary embodiment of FIG. 3, in which the casing 18 of the turbine housing 16 is not connected to the turbine housing 16 but to the bearing housing 17, the brackets 19 serves for connecting the casing 18 to the bearing housing 17. The brackets 19 have a bent contour. The brackets 19 at their first end 19a are connected to the bearing housing 17, in particular screwed. At their second end 19b located opposite, the brackets 19 are connected to the casing 18 of the turbine 14, in particular screwed.

According to FIG. 3, elongated holes 20 are formed on the two ends 19b of the bent brackets 19 which, for screwing the brackets 19 to the casing 18, screws extend into the threaded bore of the casing 18. These elongated holes 20 allow connecting the casing 18 in different angular positions on the bearing housing 17 in order to thereby make possible different attachment positions of the turbine housing. The second ends 19b of the bent brackets 19, on which the elongated holes 20 are formed, are circular segment-like contoured. At their second ends 19b, multiple brackets 19 can form a common, circular segment like-contoured section with elongated holes 20 or terminate in such a common circular segment-like section.

FIG. 2 shows a perspective view of a further casing 18. In the exemplary embodiment of FIG. 2 the casing 18 is attached to the bearing housing 17 via the brackets 19. By way of a further bracket 21, the casing 18 can be additionally mounted to the support structure 15 of the internal combustion engine 10 for the turbocharger 14.

Although not shown it is also possible that the casing 18, dependent on the installation position of the turbocharger 14 on the engine 12, is also connected to the engine 12.

Because of the invention it is not necessary that connecting elements, which serve for mounting the casing 18, have to compensate for thermally-induced relative movements between the casing 18 and the housing to be encased. For this reason, the connecting elements can be embodied rigidly, in particular with respect to ensuring a high natural frequency of the casing 18. For this reason, simple and cost-effective brackets can be employed.

The assembly of a casing according to the invention can be utilized in the region of the turbine and in the region of the compressor. In any case, the casing is not directly mounted to the housing to be encased but to an assembly which, during the operation of the turbocharger, has a temperature level corresponding to the casing.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE NUMBERS

10 Internal combustion engine
11 Generator
12 Engine
13 Cylinder
14 Turbocharger
15 Support structure
16 Turbine housing
17 Bearing housing
18 Casing
19 Bracket
19a End
19b End
20 Elongated hole
21 Bracket

1. A turbocharger (14), comprising:
a turbine configured to expand a first medium, the turbine having a turbine housing (16);
a compressor configured to compress a second medium utilizing energy extracted in the turbine during the expansion of the first medium, the compressor having a compressor housing;
a bearing housing (17) connected to the turbine housing (16) and the compressor housing, the bearing housing (17) being arranged between the turbine housing (16) and the compressor housing;
the turbocharger further comprising:
a casing (18) being at least one selected from the group of:
(a) arranged so as to surround the turbine housing (16) radially outside and axially outside, at least in certain sections, and
(b) arranged so as to surround the compressor housing radially outside and axially outside at least in certain sections,
wherein:
in a case of (a), the respective casing (18) is positioned around the turbine housing (16) without direct connection to the turbine housing (16), and, in a case of (b), the respective casing (18) is positioned around the compressor housing without direct connection to the compressor housing, and
the respective casing (18) is connected to an assembly which, during operation of the turbocharger, has a temperature level corresponding to the respective casing (18).

2. The turbocharger according to claim 1, wherein the respective casing (18) is connected to an assembly which, during the operation of the turbocharger, is exposed to a thermal load corresponding to the respective casing (18).

3. The turbocharger according to claim 2, wherein the respective casing (18) is connected to the bearing housing (17).

4. The turbocharger according to claim 3, wherein the respective casing (18) is connected to the bearing housing (17) by a plurality of bent brackets (19).

5. The turbocharger according to claim 4, wherein the brackets (19) have a first end (19a) and a second end (19b), each of the brackets (19) being connected at the first end (19a) to the bearing housing (17) and connected at the second end (19b) to the casing (18), wherein each of the second ends (19b) has elongated holes (20) formed thereon to facilitate connecting each of the second ends (19b) to the casing (18) in respective different angular positions.

6. The turbocharger according to claim 5, wherein the second ends (19b) of the brackets (19) have a segment-like circular contour.

7. The turbocharger according to claim 6, wherein the second ends (19b) of multiple brackets (19) together form a common section contoured circular segment-like with the elongated holes (20).

8. An internal combustion engine (10), comprising:
an engine (12) comprising multiple cylinders (13) for combusting fuel;
the turbocharger (14) according to claim 1 for expanding exhaust gas, which exhaust gas accrues during the combustion of fuel in the cylinders (13), and for compressing charge air, which, for combusting fuel, is fed to the cylinders (13).

9. The internal combustion engine according to claim 8, wherein the respective casing (18) is connected to the engine (12).

10. The internal combustion engine according to claim 9, further comprising a support structure (15) or console for assemblies of the internal combustion engine, wherein the respective casing (18) is connected to the support structure (15) or console.
